(19) United States
(12) Patent Application Publication
(10) Pub. No.: US 2002/0126586 A1
(43) Pub. Date: Sep. 12, 2002

(54) Timer and system

(76) Inventor: Roelof Hamberg, Venio (NL)

Correspondence Address: Corporate Patent Counsel, Philips Electronics North America Corporation, 580 White Plains Road, Tarrytown, NY, 10591, US

(21) Appl. No.: 10/049,758

(22) PCT Filed: Jun. 20, 2001
(86) PCT No.: PCT/EP01/07074

(30) Foreign Application Priority Data
Jun. 27, 2000 (EP) 00202244.0

(51) Int. Cl. G04F 8/00; G04F 10/00

(52) U.S. Cl. 368/113

(57) ABSTRACT

The timer (100) is suitable for indicating the progress of an activity, such as a movie or a download, in an intuitive fashion. Time bars (103, 104) are provided for indicating the total time of the activity in hours and minutes in hour and minute hands (101, 102) indicate the current time either relative to the start time or absolute. In case the total time exceeds sixty minutes, the minute time bar (104) can be filled completely up to the last hour, after which it is filled with the remaining time in minutes. The system, which may be a television set or a computer, uses the timer (100) to indicate the duration of programs. A rotary input element (210-510) may be used to manipulate the position of the hands (101, 102) so as to provide an intuitive way of selecting a time

The invention relates to a timer for indicating a lapse of time of a time-sequential activity with a duration, including a first hand.

The invention further relates to a system for executing a time-sequential activity, including such a timer.

A timer of the type defined in the opening paragraph is known from “Stopwatch Pointer: A Dynamic Progress Indicator”, IBM Technical Disclosure Bulletin, vol. 35, no. 92A-61894, published in June 1992.

When time-sequential activities are executed, such as playing a film or transmitting or receiving a file, indicating the elapsed time of the activity is often desired. At any rate there may be indicated how long the activity has already been executed. If it is known beforehand what the duration of the activity is, it is also possible to indicate how much time is still to go until the activity is completed. A progress indicator shows the elapsed time as a percentage of the total duration of the activity. In that case, however, the user cannot see how many hours and minutes it still takes before the activity has finished. The timer from the above publication uses the metaphor of a stopwatch, which has a minute hand and a second hand and, optionally, an hour hand. After a time-sequential activity has started, the timer shows the elapsed time by the minute hand and the second hand. A part of the timer is marked to indicate which part of the activity has already been carried out and which part still is. For example, if the activity has been executed for, for example 60 percent, 60 percent of the dial of the stopwatch is marked by coloring it.

A disadvantage of this timer is that the user cannot read in a simple manner what the remaining duration of the activity is. Marking a part of the timer on the basis of a fraction only gives an insight into the ratio between the part already executed and the remaining part, so that the user only knows that, for example, half a file has been sent or that the film has been played for 90 percent. On the basis of this information he cannot simply derive how long the completion of the activity will still take.

It is an object of the invention to provide a timer of the type defined in the opening paragraph, in which an indicative representation of a duration of an activity is realized and the timer shows the current elapsed time of the activity.

With the timer according to the invention this object is achieved in that the timer has a first time bar for representing a duration, which first time bar is positioned around a center of the timer and the timer is arranged for representing the duration of the activity on the first time bar, and for determining a current elapsed time of the activity and positioning the first hand at a position corresponding to the current elapsed time on the first time bar.

The time bar presents the total duration of the activity. This may be done in various ways. If, for example, the duration is three hours and fifteen minutes, the first time bar may represent a time of three hours and a quarter of an hour, or 195 minutes. By positioning the time bar around a center of the timer, a user may intuitively read the length and thus the duration of the activity.

The current elapsed time is represented by the hand. Since the timer is arranged substantially circularly, for example in the form of an analog clock or stopwatch, the user can immediately intuitively read what the current elapsed time is. This current elapsed time is indicated like any instant is indicated on an analog clock. The hand may also be used for determining the remaining duration of the activity. For example, when a duration of three hours is indicated on the first time bar, and the hand is halfway the representation, the user immediately knows that the completion of the activity will still take one and a half hours.

In an embodiment the timer has a graduation for reading hours and minutes and the timer is arranged for showing the duration of the activity according to the graduation. The advantage of this embodiment is that a graduation enhances the accuracy of the reading. The graduation may be complete, that is to say, with hours and minutes explicitly indicated by figures and strokes. However, it is a known fact that people can read the time from an analog clock when only a partial graduation is shown. It is often sufficient to show the times of three, six, nine and twelve o'clock or to make due with equidistant strokes every five minutes. Such designs also save space when a timer is shown, which is especially important if it is to be shown on a small surface such as, for example, in the left-hand top corner of a television screen.

In a variant of this embodiment the first time bar is positioned along the graduation. The advantage of this is that by this positioning it is also possible to have an accurate reading of the total duration of the activity. The representation of a three hour duration now corresponds to a three-hour time interval according to the graduation.

In a further embodiment the timer includes a second indicator and a second time bar, which second time bar is positioned around a center of the timer and the timer is arranged for representing the duration of the activity expressed in hours on the first time bar and for representing the duration of the activity expressed in minutes on the second time bar, and for positioning the second indicator on the second time bar at a position corresponding to the current elapsed time. An advantage of this embodiment is that the use of two time bars enables a more accurate reading of the duration of the activity. The second time bar now offers the possibility of reading the duration accurately to the minute.

In a variant of this embodiment the timer is arranged for representing the duration of the activity expressed in minutes on the second time bar after an integer number of hours has been subtracted, when the current elapsed time lies in the last hour of the duration, and otherwise for representing a sixty-minute duration. An advantage of this is that durations of more than sixty minutes are represented intuitively. The customary graduation of an analog clock cannot show more than sixty minutes. With a total duration of the activity of more than sixty minutes, the representation on the second time bar becomes less intuitive. If, for example, the duration is two hours and fifteen minutes, in this embodiment in the last hour a duration of fifteen minutes is represented in the second time bar, which the user instinctively considers “the last fifteen minutes”. In earlier hours of the duration, a duration of sixty minutes is represented in the second time bar, so that it is immediately clear that the execution of the activity has not yet arrived at the last hour.

In a further variant of this embodiment, a start point of the first time bar and the start point of the second time bar are radially on the same line. This line may be selected so that it corresponds to a certain instant, such as twelve o'clock zero minutes. The start points may be used as a beginning of the representation of the duration of the activity. By putting these start points on one line, the current elapsed time of the activity can now be read out directly, for the hands are positioned close to the time bars. If the start points now lie at twelve o'clock zero minutes, the reading of the position of the hands produces a time that corresponds to the current elapsed time.

In a further embodiment the timer is arranged for representing the duration of the activity on a time bar by marking part of the time bar between the start and the end in the time bar, the part between start and end corresponding to the duration. An advantage of this embodiment is that these markings immediately make clear what the duration of the activity is. The user may simply compare the length of the marked portions with a graduation, either explicitly present or not, and therefrom directly determine length If the start point of a marked portion of the time bar lies at, for example, two hours, and the end point at three hours, it is immediately clear that the duration is one hour.

In a variant of this embodiment the start of the time bar is chosen as the start time of the activity. An advantage of this is that the end time of the activity can now be directly read out from the position of the end point With this the user can thus intuitively determine what time the activity will have finished.

In a further embodiment, the timer is arranged for translating, in response to a selection of a point on a time bar, this point into a time and for communicating the time to a playback apparatus. The selection of a point on a time bar provides an intuitive manner of indicating a time. If, for example, a point on the first time bar is selected, which is at the top of the timer, this point is translated into twelve o'clock zero minutes. This time may be communicated to a playback apparatus, which executes this activity, so that it can change the current elapsed time of the activity to the indicated time. The selection of a point of the time bar is pre-eminently suitable for use in computer systems in which the user can select a point, for example, with his mouse.

In a further embodiment the timer comprises a rotary input element and is arranged for translating, in response to a turning of the input element, this turning into a point of time and for communicating this point of time to a playback apparatus. The turning of an input element such as a button is an intuitive manner of indicating a time. The mechanism of turning a button to change an indicated time is already known from handling analog watches and therefore does not need any extra effort to learn the handling of it on the timer.

It is also an object of the invention to provide a system of the type defined in the opening paragraph in which an indicative representation of a duration of an activity is realized and the timer represents the current elapsed time of the activity.

With the system according to the invention this object is achieved in that the system comprises a timer according to the invention.

In an embodiment the system comprises a playback apparatus.

In a further embodiment the system comprises a rotary input element and is arranged for translating in response to the tuning of the input element, this turning into a point of time and for communicating this point of time to a playback apparatus and to the timer.

These and other aspects of the invention are apparent from and will be elucidated, by way of non-limitative example, with reference to the embodiment(s) described hereinafter, in which

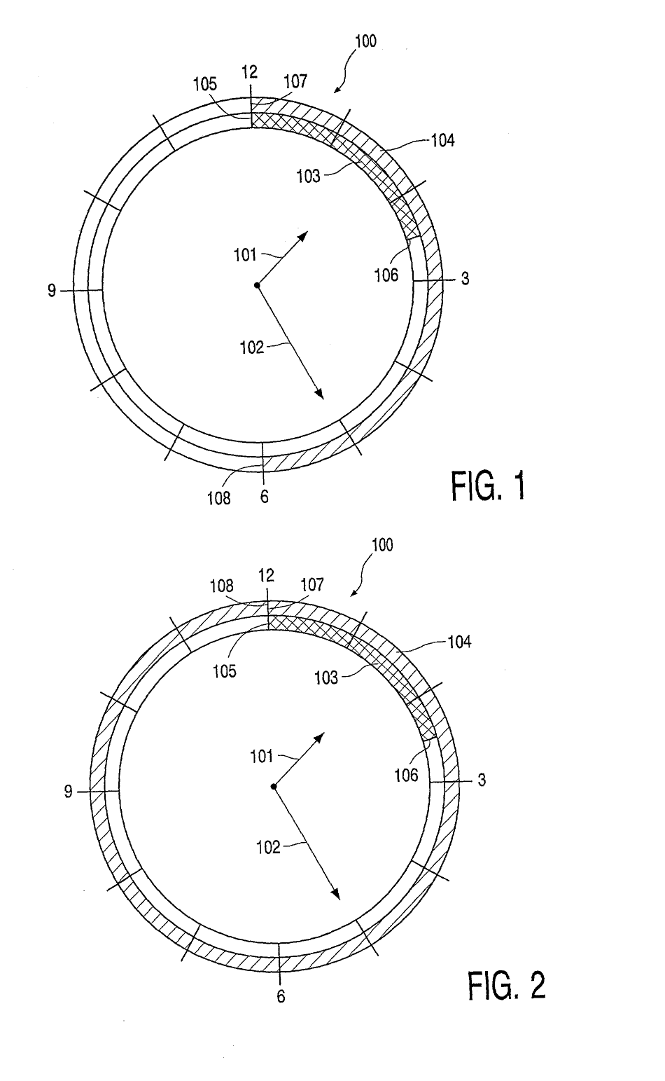

FIG. 1 is a diagrammatic representation of a first embodiment of the timer,

FIG. 2 is a diagrammatic representation of a second embodiment of the timer,

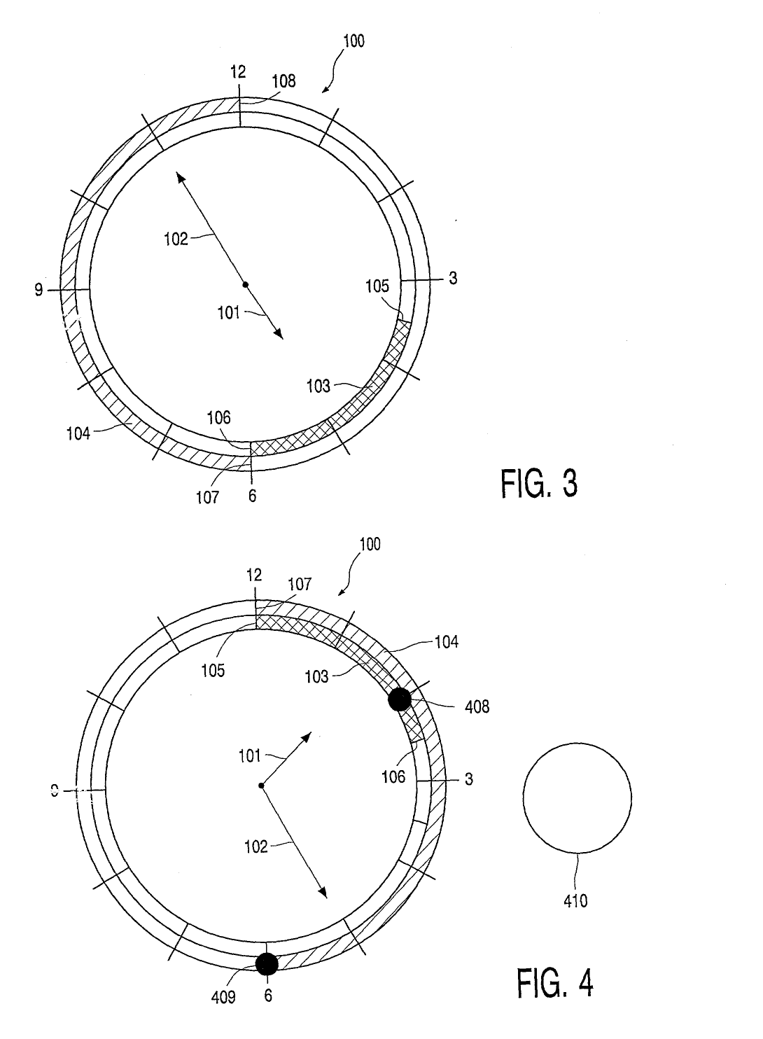

FIG. 3 is a diagrammatic representation of a third embodiment of the timer,

FIG. 4 is a diagrammatic representation of a fourth embodiment of the timer, and

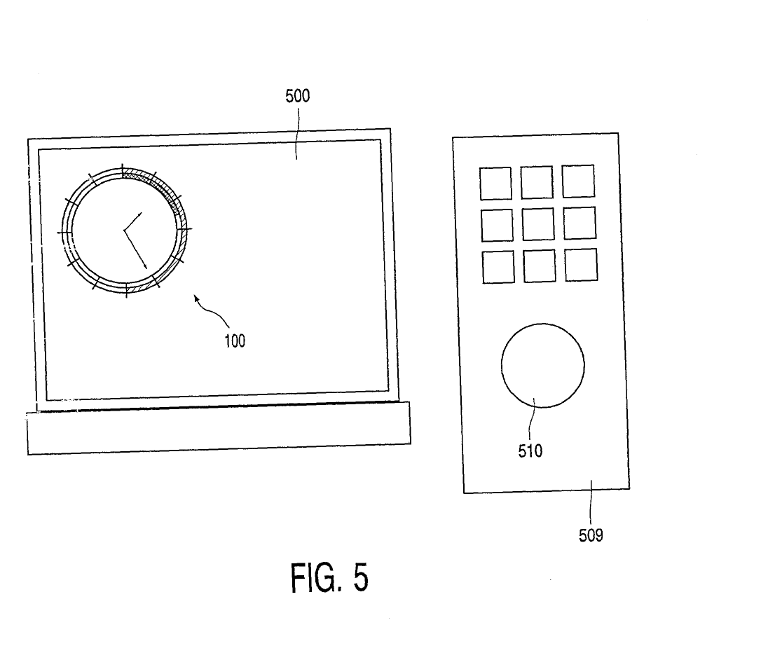

FIG. 5 is a diagrammatic representation of the system for executing a time-sequential activity, comprising a timer.

Like numbers in the drawing Figures indicate comparable or corresponding components or features. Some features indicated in the drawing Figures are typically executed in software and therefore represent software modules or objects.

FIG. 1 is a diagrammatic representation of a timer 100 for indicating a lapse of time of a time-sequential activity having a certain duration. The timer 100 comprises an hour hand 101 and a minute hand 102, which two can represent the current elapsed time of the activity. This current elapsed time may be represented relatively, as an amount of time that has elapsed since the start of the activity, or absolutely as the current time. This will be further discussed hereinbelow.

It is alternatively possible for the timer 100 to have only one hand, which may then indicate the current elapsed time either in hours or in minutes. This provides a simple embodiment of the timer 100, but to a user it should then be clear whether it is an hour hand or a minute hand. The length of the hand, which, as is known, is smaller with an hour hand than with a minute hand, may be used as an indication for this purpose.

The timer 100 may show a graduation for reading hours and minutes. In the embodiment of FIG. 1 a graduation is used on which all hours are indicated by a stroke and the times of twelve o'clock, three o'clock, six o'clock and nine o'clock are indicated by figures. Each graduation that is customary with analog clocks or stopwatches, however, is suitable. For example, it is possible to have a stroke for each full hour or for each minute or to have figures over the strokes. If, however, the timer 100 is represented on a small surface, it is often more advantageous to have a minimal graduation on which only the times of twelve o'clock, three o'clock, six o'clock and nine o'clock are indicated using strokes. It is even possible to omit the entire graduation, because people are capable of knowing the time only from the position of the hands. When a graduation is used, in whatever form, then the timer 100 represents the duration of the activity according to the graduation.

The timer 100 further has a first time bar 103 for representing a duration in hours and a second time bar 104 for representing a duration in minutes. The first time bar 103 and the second time bar 104 are positioned around a center of the timer 100. If a graduation is used, the first time bar 103 and the second time bar 104 are positioned along the graduation. This makes the reading of the duration simpler. The second time bar 104 may be omitted as appropriate. In that case the first time bar 103 can represent a duration in hours or a duration in minutes, as desired.

The example of the timer 100 given in FIG. 1 represents a duration of two hours and thirty minutes. The first time bar 103 represents the duration expressed in hours, thus two and a half hours, and the second time bar 104 represents the duration expressed in minutes, thus 150 minutes. There are various ways of representing a duration on a time bar. For example, only a part of the time bar corresponding to the time length of the duration to be represented may be shown. In the embodiment shown a part of the first time bar 103 is marked between a start 105 and an end 106 and a part of the second time bar 104 between a start 107 and an end 108. The marked parts correspond to the duration of two hours and thirty minutes. This marking may be effected, for example, by giving the marked part another color than the unmarked part, or by using different shades of color. The unmarked part may be transparent.

The representation of a duration expressed in minutes in the second time bar 104 asks for special attention. If the duration exceeds sixty minutes, the customary graduation is insufficient, because this is designed for representing a maximum of sixty minutes. There are various possibilities to still obtain a satisfactory representation of the duration expressed in minutes.

The timer 100 can in that case adapt the graduation of the second time bar 104, so that it is sufficiently large for representing the duration. With a 150-minute duration the scale may be enlarged to three hours, so that this duration can be indicated. Five sixths of the second time bar 104, which corresponds to 150 minutes on a scale having a three-hour range, can be marked. This approach, however, has the disadvantage that it is not very intuitive, because the scale no longer corresponds with the customary scale of one hour or sixty minutes.

The duration of the activity may be expressed in a number of hours and a number of minutes. Another solution is then to have the second time bar 104 simply represent this number of minutes. With a duration of 150 minutes, or two hours and thirty minutes, the second time bar 104 thus represents a duration of thirty minutes, as is shown in FIG. 1. However, this means that in the first and second hour the minute hand 102 also indicates times that go beyond thirty minutes. When utilizing a marking, unmarked parts of the second time bar 104 may then be indicated by the minute hand 102.

Therefore, it is to be preferred to apply this representation only if the current elapsed time lies in the last hour of the duration. With shorter current elapsed times a sixty-minute duration is then represented. The minute hand 107 will then never indicate an unmarked part of the second time bar 104 which, is intuitively easier for a user.

FIG. 2 shows an embodiment of the timer 100 in which the second time bar 104 represents a duration of sixty minutes. Since the current elapsed time as shown is one hour and twenty five minutes, and the duration of the activity is two hours and thirty minutes, the current elapsed time is not yet situated in the last hour of the duration of the activity. In the last hour of the duration, in this case the third hour, the embodiment of FIG. 2 will represent a thirty-minute duration on the second time bar 104.

With the timer 100 as shown in FIGS. 1 and 2, the start 105 of the first time bar 103 and the start 107 of the second time bar 104 are radially on one and the same line. This provides a relative representation of the duration of the activity. The length of the marked parts now corresponds to the duration of the activity and this length can be read directly. The marked part of the first time bar 103 corresponds to the interval between twelve o'clock and half past two, or, in other words, two and a half hours. The marked part of the second time bar 104 corresponds to the interval between zero and thirty minutes, that is, thirty minutes.

FIG. 3 shows an embodiment of the timer 100 in which the marked parts are positioned so that an absolute representation of the duration of the activity is obtained. For this purpose, the start 105 of the first time bar 103 is chosen to be the start time of the activity expressed in hours, and the start 107 of the second time bar 104 is chosen to be the start time of the activity expressed in minutes. With a start time of half past three in the afternoon this means that the start 105 lies halfway between three and four o'clock according to the graduation, and the start 107 lies at thirty minutes according to the graduation. If the total duration of the activity is two hours and thirty minutes, the end 106 lies at six o'clock and the end 108 at sixty minutes.

This embodiment may be combined with the embodiment of FIG. 2. In that case the second time bar 104 will not represent a duration of thirty minutes until the current elapsed time of the activity lies in the last hour of the duration of the activity, and before that a duration of sixty minutes. If the current elapsed time lies in the last hour of the duration of the activity, that is to say, if two hours of elapsed time have elapsed, the end 108 will be positioned so that it corresponds to the end time of the activity expressed in minutes. In the situation shown the activity has finished at exactly six o'clock, thus the end 108 will then be positioned at sixty minutes. The start 107 will be positioned at thirty minutes and the part in between will then be marked.

When a time-sequential activity is executed, the timer 100 determines a current elapsed time and indicates same. The current elapsed time may be passed on to the timer 100, for example, by a playback apparatus, or be calculated by the timer 100 itself on the basis of a given start time.

The current elapsed time is represented by the positions of the hands 101, 102. The hour hand 101 is positioned at a spot on the first time bar 103 corresponding to the current elapsed time, and the minute hand 102 is positioned at a spot on the second time bar 104 corresponding to the current elapsed time. In FIG. 1 is shown a current elapsed time of one hour and twenty five minutes, which can be read directly.

With a relative representation on the time bars 103, 104, as is shown in FIGS. 1 and 2, the read current elapsed time is equal to the length of the already executed part. The activity has thus been carried out for one hour and twenty five minutes.

With an absolute representation on the time bars 103, 104 as is shown in FIG. 3, the read current elapsed time as indicated by the hands 101, 102 is equal to the real current time. The activity was started at half past three and has gone on for one hour and twenty-five minutes. The current time is then five minutes to five. From the position of the hands 101, 102 relative to the marked parts of the time bars 103, 104 the user can determine how far the execution of the activity has already progressed and how much time the remaining part will still take.

In FIG. 4 is shown a timer 100 according to the invention which operates as described with reference to FIG. 1. The timer 100 may, however, also be used for introducing a point of time. This point of time will usually be in a desired current elapsed time at which the activity is to be continued.

A possible method of introducing a point of time is known from European patent application EP-A 511 929. According to this method the user selects a point on the time bar 103, 104. Depending on which time bar is used, the selection is translated into a number of minutes or a number of hours. A selection of the point 408 corresponds to two hours, because the point 408 lies on the first time bar 103. With a current elapsed time of one hour and twenty five minutes, this selection is translated into two hours and twenty five minutes. If the user selects the point 409, this will be translated into thirty minutes, because the point 409 lies on the second time bar 104. With a current elapsed time of one hour and twenty five minutes, this selection is then translated into a time of one hour and thirty minutes.

If the user selects a point on the time bar 103, 104, which does not belong to a marked part of this time bar 103, 104, the selection is invalid. The user may be informed hereof. However, since the user can see from the time bars how long the activity lasts, he will be less fast inclined to select a point of time that is later than the total duration of the activity.

After a point of time has been determined, this point of time is communicated to a playback apparatus. This apparatus can then adapt the current elapsed time of the time-sequential activity to the point of time and carry on at that point of time with executing the activity.

It is alternatively possible to provide the timer 100 with a rotary input element, such as a turning knob 410. In a computer that shows, for example a film, the timer 100 can be shown with in its vicinity a turning knob 410. The user can then manipulate this turning knob 410 with his mouse or another input medium and thus change the current elapsed time as described above. The hands may also be used as a rotary input element, so that an even more direct manipulation of the current elapsed time is possible. The user then moves the hands by means of his mouse or other input medium and thus directly changes the current elapsed time.

FIG. 5 shows a system for executing a time-sequential activity, which system comprises a timer 100 according to the invention. The timer 100 may be arranged in all manners as described above. The system further includes a playback apparatus 500. In FIG. 3 the system is a television set suitable for showing television programs. The timer 100 then indicates the elapsed time of the television program. The system may also be a computer, for example. This computer can then use the timer 100 to indicate the elapsed time of transmitting or receiving a file or to indicate the elapsed time of playing a video or audio file. For this purpose the system has to communicate the current elapsed time of the activity to the timer 100, so that this timer 100 can show the current elapsed time. Prior to the start of the activity, also the total duration of the activity is to be communicated to the timer 100.

The system also includes a remote control 509. The remote control 509 has a rotary input element in the form of a turning knob 510. With existing wrist watches a turning knob is often used to change the currently shown time. The use of a turning knob is therefore a highly intuitive manner of selecting a point of time. The user turns the knob 510 clockwise for a future point of time and counterclockwise for a point of time in the past. The remote control 509 communicates information about the timing of the knob 510 to the playback apparatus 500. This playback apparatus 500 can in response to receiving this information continue the execution of the activity at the thus selected point of time. When a film is shown, the turning knob 510 may be used for fast winding and fast rewinding.

Translating the turning of the knob 510 to a point of time strongly depends on the application and the desired accuracy. It is possible to have one full turn of 360 degrees of the knob correspond to a lapse of time of one hour, so that the operation is identical to the operation of the turning knob of the conventional wrist watch. Turning movements of more or less than 360 degrees may then proportionally hereto be translated to a lapse of time that is added to or subtracted from the current elapsed time to determine a point of time at which the execution is to be continued.

The timer 100 receives the thus selected point of time as the new current elapsed time and puts the hands 101, 102 in a corresponding position as described above. If this takes place sufficiently fast, this provides a mechanism by which the user gets real-time feedback for turning the knob 510. For the best result the execution of the activity is thus to be accelerated in proportion to the speed at which the turning knob 510 is moved.

It will be evident that the timer 100 can be simply extended by a third time bar for representing a duration in seconds and by a second hand which is positioned in a comparable fashion to the hour hand 101 and the minute hand 102. This is particularly advantageous when a lapse of time of less than sixty minutes is to be shown, because then an hour hand is hardly useful. The third time bar may then be shown in lieu of the first time bar 103, although this may cause confusion if alternately durations of more of less than sixty minutes are shown.

The timer 100 may be realized in many fashions. It may be arranged in part or in full in software. The timer 100 may form part of an On-Screen Display in a television set. The timer 100 may be shown when a file is sent or received by a computer, to replace or complement existing progress indicators. It may be shown during the playback of a film or television program. It may be advantageous to have a transparent timer 100 in the background, so that as small a portion of the film or television program as possible is covered by the timer. The timer 100 may optionally also be hidden until invoked by the user.

1. A timer (100) for indicating a lapse of time of a time-sequential activity with a duration, including a first hand (101), characterized in that the timer (100) has a first time bar (103) for representing a duration, which first time bar (103) is positioned around a center of the timer (100) and the timer (100) is arranged for representing the duration of the activity on the first time bar (103), and for determining a current elapsed time of the activity and positioning the first hand (101) at a position corresponding to the current elapsed time on the first time bar (103).

2. A timer (100) as claimed in claim 1, characterized in that the timer (100) has a graduation for reading hours and minutes and the timer (100) is arranged for showing the duration of the activity according to the graduation.

3. A timer (100) as claimed in claim 2, characterized in that the first time bar (103) is positioned along the graduation.

4. A timer (100) as claimed in claim 1, characterized in that the timer includes a second indicator (102) and a second time bar (104), which second time bar (104) is positioned around a center of the timer (100) and the timer (100) is arranged for representing the duration of the activity expressed in hours on the first time bar (103) and for representing the duration of the activity expressed in minutes on the second time bar (104) and for positioning the second indicator (102) on the second time bar (104) at a position corresponding to the current elapsed time.

5. A timer (100) as claimed in claim 4, characterized in that the timer (100) is arranged for representing the duration of the activity expressed in minutes on the second time bar (104) after an integer number of hours has been subtracted when the current elapsed time lies within the last hour of the duration, and otherwise for representing a sixty minute duration.

6. A timer (100) as claimed in claim 4, characterized in that a start point (105) of the first time bar (103) and a start point (107) of the second time bar (104) are radially on one line.

7. A timer (100) as claimed in claim 1, characterized in that the timer (100) is arranged for representing the duration of the activity on a time bar (103, 104) by marking part of the time bar (103, 104) between a start (105, 107) and an end (106, 108) in the time bar (103, 104), the part between the start (105, 107) and end (106, 108) corresponding to the duration.

8. A timer (100) as claimed in claim 7, characterized in that the start (105, 107) of the time bar (103, 104) is chosen as the start time of the activity.

9. A timer (100) as claimed in claim 1, characterized in that the timer (100) is arranged for translating, in response to a selection of a point on the time bar (103, 104), this point on a time bar (103, 104) into a point of time and for communicating this point of time to a playback apparatus (500).

10. A timer (100) as claimed in claim 1, characterized in that the timer (100) further includes a rotary input element (410; 510) and is arranged for translating, in response to a turning of the input element (410; 510), this turning into a point of time and for communicating this point of time to a playback apparatus (500).

11. A system for executing a time-sequential activity, characterized in that the system comprises a timer (100) as claimed in one of the preceding claims.

12. A system as claimed in claim 11, characterized in that the system further includes a playback apparatus (500).

13. A system as claimed in claim 11 or 12, characterized in that the system further includes a rotary input element (510) and is arranged for translating, in response to the turning of the input element (510), this turning into a point of time and for communicating this point of time to a playback apparatus (500) and to the timer (100).
